(19) United States
(12) Patent Application Publication
(10) Pub. No.: US 2025/0346237 A1
(43) Pub. Date: Nov. 13, 2025

(54) VIRTUAL INERTIAL MEASUREMENT

(71) Applicant: GM GLOBAL TECHNOLOGY OPERATIONS LLC, DETROIT, MI (US)

(72) Inventors: Klaus Trangbaek, Ein Vered (IL); Mohammadali Shahriari, Markham (CA); Reza Zarringhalam, Whitby (CA); Michael Baltaxe, Kfar Saba (IL); Sahar Vilan, Atlit (IL)

(21) Appl. No.: 18/656,900

(22) Filed: May 7, 2024

(51) Int. Cl. B60W 40/10; B60W 50/02; B60W 50/023

(52) U.S. Cl. CPC B60W 40/10; B60W 50/0205; B60W 50/023; B60W 2050/021; B60W 2050/0215; B60W 2520/00; B60W 2555/20

(57) ABSTRACT

A system for measuring vehicle parameters includes an inertial measurement unit configured to measure an inertial parameter of a vehicle, and a virtual measurement unit configured to receive a plurality of measured parameters from one or more other sensors of the vehicle, and emulate the inertial parameter by combining the plurality of measured parameters. The system also includes a controller configured to control vehicle operation based on at least one of the measured inertial parameter and the emulated inertial parameter.

### INTRODUCTION

The subject disclosure relates to the art of vehicle control. More particularly, the subject disclosure relates to systems and methods for improving inertial measurements.

Vehicles are increasingly equipped with sensors and perception devices that improve the awareness of vehicle control systems and drivers, and can thereby provide for autonomous control and/or driver support. Inertial measurement units are typically included to measure inertial parameters such as acceleration, yaw rate and others.

### SUMMARY

In one exemplary embodiment, a system for measuring vehicle parameters includes an inertial measurement unit configured to measure an inertial parameter of a vehicle, and a virtual measurement unit configured to receive a plurality of measured parameters from one or more other sensors of the vehicle, and emulate the inertial parameter by combining the plurality of measured parameters. The system also includes a controller configured to control vehicle operation based on at least one of the measured inertial parameter and the emulated inertial parameter.

In addition to one or more of the features described herein, the plurality of measured parameters include at least one of a parameter indicative of an environment around the vehicle and a vehicle dynamics parameter.

In addition to one or more of the features described herein, the plurality of measured parameters include at least one parameter derived from a visual odometry process using a series of camera images, and a dynamics parameter measured by a vehicle sensor.

In addition to one or more of the features described herein, the virtual measurement unit is configured to apply a correction to the measured inertial parameter.

In addition to one or more of the features described herein, the virtual measurement unit is configured to enhance the measured inertial parameter by fusing the measured inertial parameter and the plurality of measured parameters, to generate the emulated inertial parameter associated with a higher performance inertial measurement.

In addition to one or more of the features described herein, the emulated inertial parameter is used to detect a fault in the inertial measurement unit.

In addition to one or more of the features described herein, the virtual measurement unit is configured to provide redundancy to the inertial measurement unit, and operate to provide inertial measurements when the inertial measurement unit is in a fault condition.

In addition to one or more of the features described herein, the inertial parameter is associated with a plurality of degrees of freedom, the measured inertial parameter is provided for a first subset of the plurality of degrees of freedom, and the emulated inertial parameter is provided for a second subset of the plurality of degrees of freedom.

In another exemplary embodiment, a method of measuring vehicle parameters includes measuring an inertial parameter of a vehicle by an inertial measurement unit, receiving a plurality of measured parameters from one or more other sensors of the vehicle by a virtual measurement unit, emulating the inertial parameter by combining the plurality of measured parameters, and controlling vehicle operation based on at least one of the measured inertial parameter and the emulated inertial parameter.

In addition to one or more of the features described herein, the plurality of measured parameters includes at least one of a parameter indicative of an environment around the vehicle and a vehicle dynamics parameter.

In addition to one or more of the features described herein, the method includes applying a correction to the measured inertial parameter based on the emulated inertial parameter.

In addition to one or more of the features described herein, emulating the inertial parameter includes enhancing the measured inertial parameter by fusing the measured inertial parameter and the plurality of measured parameters, to generate the emulated inertial parameter associated with a higher performance inertial measurement.

In addition to one or more of the features described herein, the method includes detecting a fault in the inertial measurement unit based on the emulated inertial parameter.

In addition to one or more of the features described herein, the virtual measurement unit is configured to provide redundancy to the inertial measurement unit, and operate to provide inertial measurements when the inertial measurement unit is in a fault condition.

In yet another exemplary embodiment, a vehicle system includes a memory having computer readable instructions, and a processing device for executing the computer readable instructions, the computer readable instructions controlling the processing device to perform a method. The method includes measuring an inertial parameter of a vehicle by an inertial measurement unit, receiving a plurality of measured parameters from one or more other sensors of the vehicle by a virtual measurement unit, emulating the inertial parameter by combining the plurality of measured parameters, and controlling vehicle operation based on at least one of the measured inertial parameter and the emulated inertial parameter.

In addition to one or more of the features described herein, the plurality of measured parameters include at least one parameter derived from a visual odometry process using a series of camera images, and a dynamics parameter measured by a vehicle sensor.

In addition to one or more of the features described herein, the method includes applying a correction to the measured inertial parameter based on the emulated inertial parameter.

In addition to one or more of the features described herein, emulating the inertial parameter includes enhancing the measured inertial parameter by fusing the measured inertial parameter and the plurality of measured parameters, to generate the emulated inertial measurement associated with a higher performance inertial measurement.

In addition to one or more of the features described herein, the method includes detecting a fault in the inertial measurement unit based on the emulated inertial parameter.

In addition to one or more of the features described herein, the virtual measurement unit is configured to provide redundancy to the inertial measurement unit, and operate to provide inertial measurements when the inertial measurement unit is in a fault condition.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including aspects of a user interaction and prediction system, in accordance with an exemplary embodiment;

FIG. 2 depicts a control system including a physical inertial measurement unit (IMU) and a processing module configured to emulate inertial measurements, in accordance with an exemplary embodiment;

FIG. 3 depicts a control system including a processing module configured to emulate inertial measurements, in accordance with an exemplary embodiment;

FIG. 4 is a flow diagram depicting aspects of a method of measuring vehicle parameters, in accordance with an exemplary embodiment;

FIG. 5 depicts a vehicle control system including a physical IMU and a processing module configured to emulate inertial measurements and provide redundancy and/or fault operation, in accordance with an exemplary embodiment;

FIG. 6 depicts a vehicle control system including a physical IMU and a processing module configured to emulate inertial measurements and provide fault mitigation, in accordance with an exemplary embodiment;

FIG. 7 depicts a vehicle control system including a physical IMU and a processing module configured to emulate inertial measurements and correct IMU measurements, in accordance with an exemplary embodiment;

FIG. 8 depicts a vehicle control system including a physical IMU and a processing module configured to emulate inertial measurements and enhance IMU measurements, in accordance with an exemplary embodiment;

FIG. 9 is a flow diagram depicting aspects of a method of determining inertial parameters based on perception data (e.g., camera images), in accordance with an exemplary embodiment;

FIG. 10 is a flow diagram depicting aspects of a method of determining inertial parameters based on perception data, in accordance with an exemplary embodiment; and

FIG. 11 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with one or more exemplary embodiments, methods and systems are provided for measuring vehicle dynamics, evaluating inertial sensor measurements and/or correcting inertial sensor measurements. An embodiment of a vehicle control system includes an inertial measurement unit (IMU) and a processing module configured to acquire measurements from other sensors and emulate IMU measurements. Other sensor measurements may include sensors for measuring dynamic parameters (e.g., wheel speed sensors and estimation of vehicle position, movement and/or velocity from a visual odometry process).

The processing module, also referred to as a “virtual IMU,” is configured to combine measurements of different parameters. For example, a sensor fusion process is used, whereby a set of equations is solved for a set of unknown inertial parameters. In an embodiment, the sensor fusion accounts for the uncertainty or reliability of various sensor measurements.

The emulated IMU measurements may be used to support and/or enhance a physical IMU. For example, the virtual IMU can provide redundancy for fault operation and/or used for fault detection. Inertial measurements may be enhanced, for example, by using emulated parameters to correct IMU measurements (e.g., bias correction). In another example, the virtual IMU is configured to emulate inertial measurements associated with higher performance inertial measurements (i.e., higher performance than the physical IMU).

The virtual IMU is modular, in that the virtual IMU can emulate IMU measurements based on inertial parameters irrespective of the source of other parameter measurements. The virtual IMU may output the same inertial measurement data as a physical IMU, and thus the virtual IMU can be used with other components (e.g., processing devices and/or software that receive IMU measurement data) without the need for re-configuring such components.

Embodiments described herein present a number of advantages. For example, the embodiments provide for performance improvements and improvements in fault tolerance of existing physical IMUs. For example, a virtual IMU as described herein can be used to provide fault detection and/or improvements in the accuracy of physical IMU measurements.

In addition, a virtual IMU can be used in place of a physical IMU for redundancy and fault detection. For example, current vehicle systems include a high performance IMU, such as an IMU having an Automotive Safety Integrity Level of D (ASIL-D), in combination with a lower performance IMU (e.g., an ASIL-B rated IMU). Embodiments described herein allow for elimination of the physical high performance IMU, thereby reducing complexity while maintaining redundancy and without sacrificing performance.

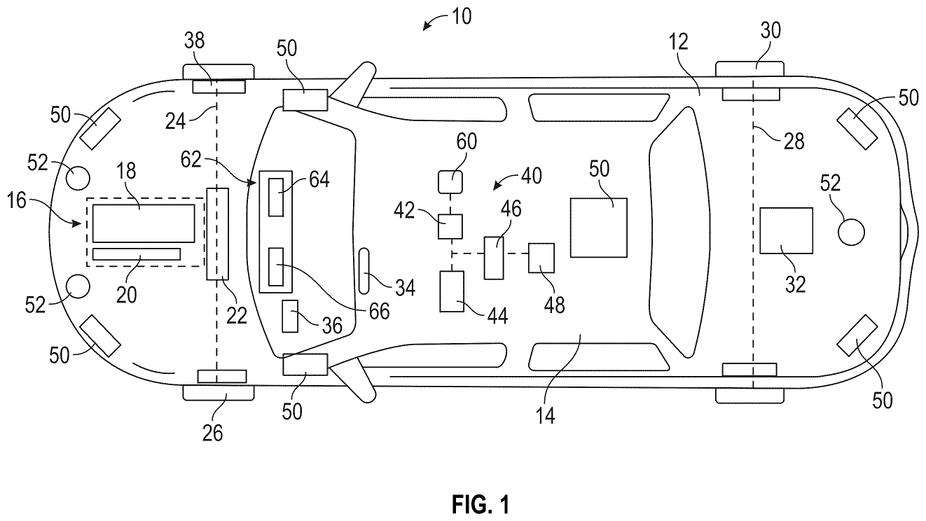

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion systems 16 and other vehicle components, such as a braking subsystem, a suspension system, a steering subsystem, and if the vehicle is a hybrid electric vehicle, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. In an embodiment, the propulsion system 16 includes an electric motor 20, and may include one or more additional motors positioned at various locations. The vehicle 10 may be a fully electric vehicle having one or more electric motors.

The propulsion system 16 includes additional components for support of propulsion, such as a cooling system and a transmission system 22 for controlling the transfer of torque from the engine 18 and/or motor 20 to a front drive shaft or front axle 24. The front axle 24 is connected to front wheels 26.

The propulsion system 16 is not limited to the specific configuration shown. For example, the propulsion system 16 can include additional components, such as a transmission system for transferring torque to a rear drive shaft or rear axle 28 connected to rear wheels 30. As previously noted, the propulsion system may include additional torque generation devices, such as a rear electric motor 32. The vehicle may include various control devices for controlling aspects of vehicle operation, such as a steering wheel 34, an acceleration pedal 36, and brakes 38.

The vehicle 10 includes various sensors and measurement systems, which may be used in conjunction with a vehicle control system 40 for supporting vehicle operation. An inertial measurement unit (IMU) 42 is included for measuring vehicle parameters such as heading, speed, acceleration, turn rate, inclination and others. The IMU 42 can be used to estimate parameters such as orientation, roll, yaw and pitch. The various parameters measured by the IMU are referred to as “inertial parameters.”

Other sensors (collectively denoted as sensors 44) may be included for monitoring control devices, such as wheel speed sensors connected to one or more of the wheels 26 and 30, a steering sensor connected to the steering wheel 34, brake sensors and others. The other sensors 44 may also include a global positioning system (GPS) unit for location and/or a Doppler GPS unit for velocity relative to global coordinates.

The vehicle control system 40 may be used for tracking vehicle dynamics, as well as for autonomous control or semi-autonomous control (e.g., driver assistance) of the vehicle. In an embodiment, the control system 40 includes an estimation module 46 that receives inertial measurements from the IMU 42 and the sensors 44, and estimates vehicle and road parameters. The vehicle and road parameters may be provided to a controller 48, such as an advanced driver assistance system (ADAS) controller 48.

The sensors and measurement systems, in an embodiment, includes a perception system for detecting and monitoring the environment around the vehicle. The perception system includes, for example, one or more optical cameras 50 are configured to take images, which may be still images and/or video images. Additional devices or sensors may be included in the vehicle 10, such as one or more radar assemblies 52. The perception system is not so limited and may include other types of sensors, such as lidar and infrared sensors.

In an embodiment, the vehicle 10 and/or the control system 40 includes a processing module 60 configured to receive measurements from at least one of the other sensors 44, and use such measurements to construct or emulate inertial measurements. This module is also referred to as a “virtual IMU” 60. As discussed further, the virtual IMU 60 may be included in addition to the physical IMU 42 (e.g., for redundancy, fault protection and/or enhancement of the physical IMU), or the virtual IMU 60 is included in place of the physical IMU 42.

The vehicle 10, the control system 40 and other vehicle systems include or are connected to an on-board computer system 62 that includes one or more processing devices 64 and a user interface 66. The user interface 66 may include a touchscreen, a speech recognition system and/or various buttons for allowing a user to interact with features of the vehicle. The user interface 66 may be configured to interact with the user via visual communications (e.g., text and/or graphical displays), tactile communications or alerts (e.g., vibration), and/or audible communications.

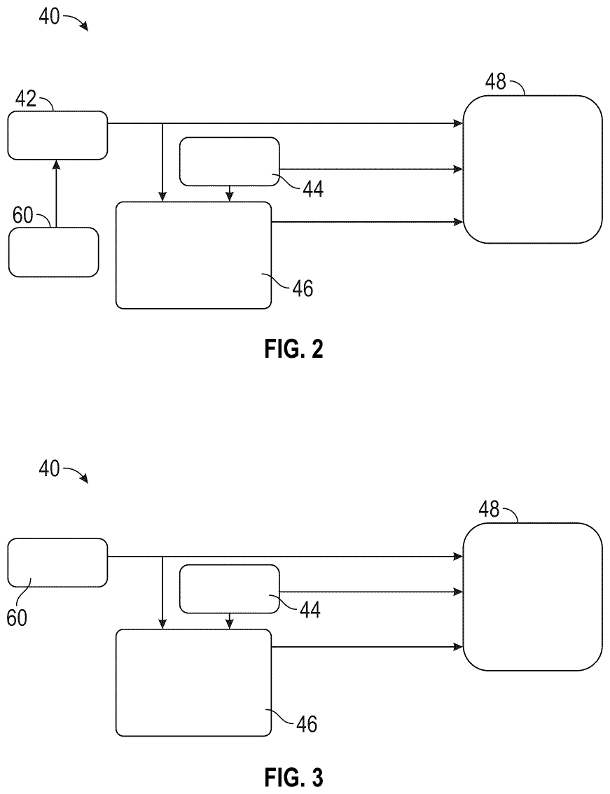

FIG. 2 shows an example of the control system 40, in which the virtual IMU 60 is configured to enhance or support the IMU 42. FIG. 3 shows an example in which the virtual IMU 60 emulates inertial measurements (without a physical IMU) and provides the emulated measurements to the estimation module 46.

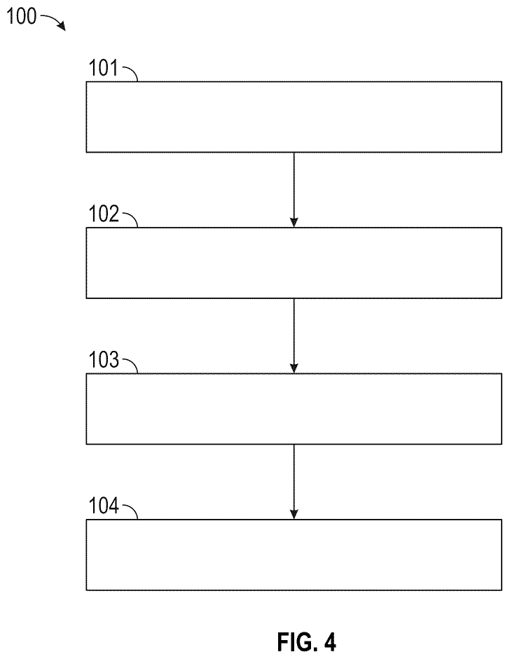

FIG. 4 depicts a method 100 of emulating IMU measurements and/or performing one or more actions based on emulated IMU measurements. The method 100 is discussed in conjunction with blocks 101-104. The method 100 is not limited to the number or order of steps therein, as some steps represented by blocks 101-104 may be performed in a different order than that described below, or fewer than all of the steps may be performed.

The method 100 is discussed in conjunction with the vehicle of FIG. 1 and a processing system, which may be, for example, the computer system 62, the control system 40, or a combination thereof. Aspects of the method 100 are discussed in conjunction with the vehicle 10 for illustration purposes. It is noted the method 100 is not so limited and may be performed by any suitable processing device or system, or combination of processing devices.

At block 101, the IMU 42 measures one or more parameters of the vehicle 10, referred to herein as “inertial parameters.” Measurements of inertial parameters by the IMU 42 are referred to as “measured inertial parameters.” Examples of inertial parameters include lateral, longitudinal and vertical accelerations, and pitch, yaw and roll rates.

At block 102, a measurement or measurements from one or more other sensors is collected. Parameters measured by the other sensors are collectively referred to as “dynamic parameters.” The dynamic parameters, in an embodiment, are parameters related to vehicle position, vehicle dynamics and/or an environment around the vehicle 10. Any combination of suitable measurements from any number of sensors may be used. As discussed further herein, dynamic parameters may include parameters measured by vehicle sensors (e.g., wheel speed, steering angle, etc.) and/or parameters derived from the perception system (e.g., position, heading, velocity, etc.). Other sources of information may be used, such as map data.

It is noted that embodiments are not limited to any particular sensor device, sensor system or vehicle system. The IMU 42 can receive dynamic parameters and other information from any suitable sensor(s) and is agnostic with respect to the source of this information. In addition, the virtual IMU 60 can provide the same signals (e.g. yaw rate, lateral acceleration) as the physical IMU 42. Therefore, other software components can stay the same, without considering whether the signals come from one or the other. Thus, the IMU 42 can substitute the IMU 42 in a modular fashion and be incorporated into existing systems without the need to modify such systems.

At block 103, the dynamic parameters are input to the virtual IMU 60, which emulates or reconstructs measurements of the inertial parameters (referred to as “emulated inertial parameters” or “emulated parameters”).

In an embodiment, inertial parameters are emulated by choosing a suitable set of dynamic parameters as unknowns, and collecting relations between the sensor measurements (block 102) and the unknowns as a set of equations. If desired, equations can be linearized around estimated values. The set of equations is solved to get a set of unknowns corresponding to the emulated inertial parameters.

It is noted that the method 100 may include both measuring inertial parameters by the IMU 42 (block 101) and generating emulated inertial parameters by the virtual IMU 60. For example, the emulated inertial measurements are used to correct the IMU 42 measurements, or used to enhance the performance of the IMU 42 by fusing measured inertial parameters with the dynamic parameters. Examples of such enhancements include fault detection, correction of inertial parameter measurements, noise reduction, improvement in degrees of freedom, and others.

Alternatively, the method 100 may include blocks 102 and 103 in the absence of measurements of inertial parameters by the IMU 42. For example, the virtual IMU 60 may be used in place of the IMU 42. In other examples, the virtual IMU 60 may be used to emulate inertial parameters when the IMU 42 is in a fault condition or otherwise unavailable.

At block 104, one or more control actions may be performed based on the emulated parameters. For example, the measured and/or emulated inertial parameters may be used by the controller 48 to control the vehicle 10, directly or as a redundant inertial sensor for operation during failure (fail-op).

In an embodiment, if the IMU 42 fails during automated driving, the virtual IMU 60 takes over and emulates inertial parameter measurement signals. For example, upon detecting a fault or failure of the IMU 42, the virtual IMU 60 provides emulated IMU signals for a time period that is sufficient for the vehicle to perform any emergency maneuvers. The vehicle 10 may then autonomously come to a stop or hand over manual control to a driver.

It is noted that the embodiments are described with reference to examples of sensors and dynamic parameters, for illustration purposes. However, the embodiments are not limited to the specific sensors, data types, dynamic parameters and inertial parameters discussed therewith.

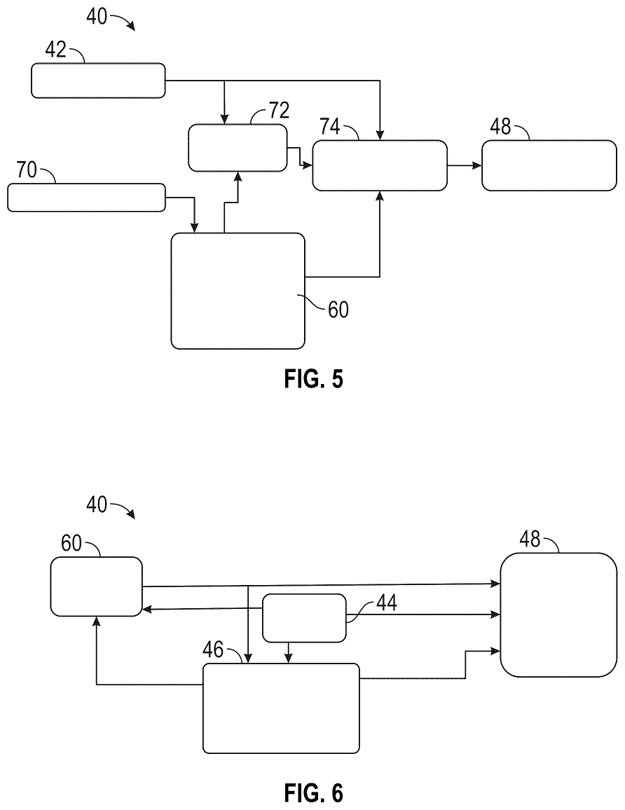

FIG. 5 schematically depicts an embodiment of the control system 40, in which the virtual IMU 60 emulates inertial measurements for failure detection and/or redundancy. In this embodiment, the virtual IMU 60 receives dynamic parameter data from various sensors. The dynamic parameter data includes, for example, map and GPS data, wheel speeds and steering angle.

The dynamic parameters also include vehicle information derived from the perception system. For example, a visual odometry module 70 collects data from the perception system, such as a series of camera images, and processes the camera images to derive information such as vehicle heading and velocity. In this example, visual odometry information is not provided to the IMU 42.

The dynamic parameters (including outputs from the visual odometry module 70) are input to the virtual IMU 60, which calculates emulated inertial parameters. The measured inertial parameters and the emulated inertial parameters are provided to a failure detection module 72, which compares the measurements and determines that there is a fault or failure if there is sufficient difference between the measured inertial parameters and the emulated inertial parameters.

If a fault or failure is detected, a failure operation (fail op) module 74 directs the controller 48 to operate the vehicle using the emulated inertial parameters. In this way, the virtual IMU 60 provides redundancy and the capability for operation when the IMU 42 is faulty, without the need for an addition physical IMU.

The IMU 42 and the virtual IMU 60 may have the same performance characteristics or different performance characteristics. For example, the IMU 42 has four degrees-of-freedom (4 DOF), and the virtual IMU 60 emulates a 4 DOF IMU.

In another example, the virtual IMU 60 has a higher performance characteristic than the IMU 42 (e.g., higher accuracy, lower bias, less noise, etc.), and thus can enhance inertial measurements. In this example, emulating the inertial parameters is based on fusing or combining the dynamic parameters with the lower performance inertial measurements from the IMU 42.

In an embodiment, the inertial measurements are associated with a plurality of degrees of freedom (e.g., 6 DOF), and the IMU 42 is used to provide an inertial measurement for a first subset (one or more) of the plurality of degrees of freedom. The virtual IMU 60 provides an emulated measurement of the inertial parameter for a second subset of the plurality of degrees of freedom.

The virtual IMU 60 may have higher performance for one or more DOFs. In this case, the IMU 42 may provide lower performance measurements for all DOFs, and the virtual IMU 60 can enhance these measurements by supplementing the IMU 42 measurements for the higher performance DOFs.

In some cases, the IMU 42 provides higher performance measurements of one or more DOFs, and lower performance measurements for the remaining DOFs. The virtual IMU 60 can provide higher performance measurements for the remaining DOFs.

FIG. 6 depicts an embodiment in which the virtual IMU 60 is used for fault mitigation. If the IMU 42 fails or is otherwise unavailable, inertial measurements may be emulated by fusing dynamic parameters such as GPS location, wheel speed data and image data from a camera. The emulated inertial parameters are then provided to the controller 48.

For example, if the IMU 42 fails, measurements from the other sensors are provided directly to the virtual IMU 60. One or more of the dynamic parameters may be parameters derived from the estimation module 46 and then provided to the virtual IMU 60. For example, inertial parameters such as lateral acceleration and yaw rate are emulated using wheel speed, steering angle, and understeer coefficient.

Slowly-changing parameters, such as understeer coefficient Kus, can be estimated from IMU measurements and other measurements (e.g. wheel speed, steering angle, etc.). For example, if the IMU 42 is functioning properly, parameters such as Kus are estimated using the IMU 42. If the IMU 42 fails, parameter estimates are locked or fixed (i.e., the parameter estimates are kept constant), and the virtual IMU 60 uses the fixed estimated parameters in an open loop fashion to emulate the IMU 42.

For example, if the IMU 42 fails, inertial parameters including yaw rate ω_{z} and acceleration can be constructed from a dynamic parameters and a vehicle model, in combination with steady state assumptions.

The yaw rate ω_{z} can be estimated from steering angle, understeer coefficient Kus and longitudinal velocity Vₓ. Lateral acceleration A_{y} can be estimated from the yaw rate as follows (if lateral velocity V_{y} is assumed to be zero or constant):

$${A}_{y} = {V}_{x} * {ω}_{𝓏} ,$$

$${A}_{yg} = {A}_{y} + g sin ( b ) ,$$

where A_{yg} is lateral acceleration including gravity g, and b is bank angle. Longitudinal acceleration Aₓ can be determined based on sample-to-sample difference of wheel speeds or GPS locations.

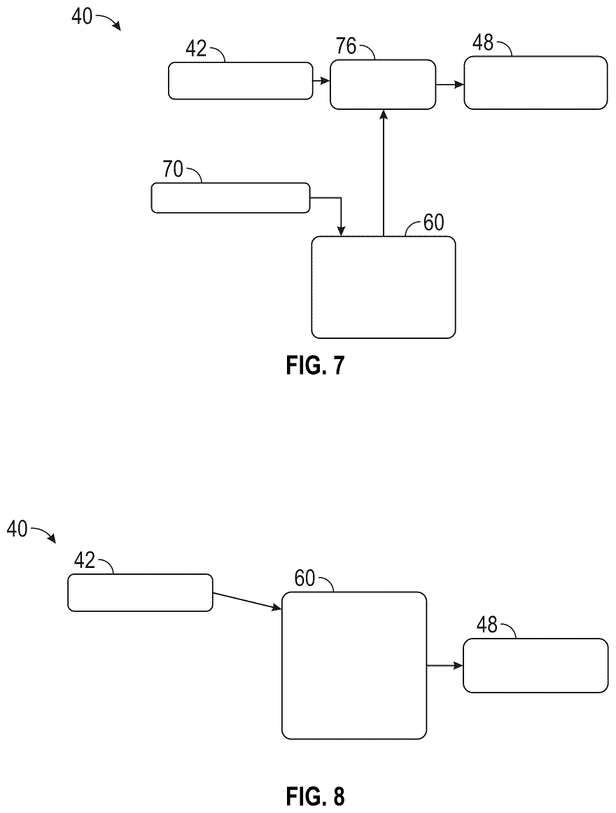

FIGS. 7 and 8 depict embodiments in which the IMU 60 is used to enhance measurements from the IMU 42.

FIG. 7 depicts an embodiment of the control system 40, in which the virtual IMU 60 is used to enhance the IMU 42 by providing corrections to inertial measurements performed by the IMU 42. In this embodiment, visual odometry information and dynamic parameters from other sensors are combined to emulate inertial parameters. Inertial measurements from the IMU 42, and outputs from the virtual IMU 60, are provided to a filter 76 for correcting the inertial measurements. The filter may be configured for bias correction, scale factor correction, noise correction, and others.

FIG. 8 depicts an embodiment of the control system 40, in which the virtual IMU 60 is used to enhance the IMU 42 by emulating improved inertial measurements (i.e., measurements provided by a higher performance IMU). For example, a three degree-of-freedom (3 DOF) IMU 42 can be enhanced by fusing 3 DOF inertial measurements with other sensor measurements (e.g., camera, GPS and wheel speed) to emulate inertial measurements in 6 DOF.

The enhancement of FIG. 8 is accomplished by fusing measurements from the IMU 42 with measurements from one or more sensors. Fusion of such measurements is discussed further herein.

In an embodiment, enhanced inertial parameters measurements are achieved by collecting a set of dynamic parameter measurements, and performing an approximation to derive relations between dynamic parameters and inertial parameters. The relations are represented by equations, which may take any suitable form. The equations are solved for unknowns corresponding to the desired inertial parameters. Uncertainty or reliability of individual sensor measurements may be accounted for using a scaling factor.

In an embodiment, for a given sensor i, a set of inertial parameters is calculated using the following matrix equation:

$${y}_{i} = ( {C}_{i} ) x ,$$

where Cᵢ is a full-row-rank matrix and yᵢ is given by recent measurements. The matrix Cᵢ is inverted to determine the set of inertial parameters as a parameter matrix x.

An example of an inertial parameter matrix x is shown as:

$$x = [ \begin{matrix}{A}_{x} \\ {A}_{y} \\ {A}_{z} \\ {ω}_{x} \\ {ω}_{y} \\ {ω}_{z} \\ {V}_{x} \\ {V}_{y} \\ {V}_{z} \\ b \\ g\end{matrix} ] ,$$

where Aₓ is longitudinal acceleration, A_{y} is lateral acceleration, and A_{z} is vertical acceleration. Vₓ is longitudinal velocity, V_{y} is lateral velocity, and V_{z} is vertical velocity. ωₓ, ω_{y}, ω_{z} are roll, pitch and yaw rate respectively.

The following is an example of reconstructing inertial measurements from other sensors. In this example, yaw rate ω_{z} and lateral acceleration A_{y} are reconstructed from GPS data, road bank angle acquired from a map and wheel speeds provide a secondary estimate of yaw rate. The GPS data, in this example, is used to determine velocity by taking a number of consecutive samples of an absolute velocity vector Vᵢ, where i is a sampling instance.

The yaw rate ω_{z} is the change in body yaw (absolute angle Ψᵢ), which is equal to absolute velocity angle ∠Vᵢ and side slip. Side slip is equal to V_{yi}/Vₓ, where V_{yi} is lateral velocity at a sampling instance i, and Vₓ is longitudinal velocity. For example, body yaw for consecutive sample times is represented as:

$${Ψ}_{2} = ∠ {V}_{2} - {V}_{y 2} / {V}_{x}$$

$${Ψ}_{1} = ∠ {V}_{1} - {V}_{y 1} / {V}_{x} .$$

The yaw rate can be found using the following equation:

$${t}_{12} {ω}_{𝓏 1} = {Ψ}_{2} - {Ψ}_{1} = ∠ {V}_{2} - ∠ {V}_{1} - {V}_{y 2} / {V}_{x} + {V}_{y 1} / {V}_{x} ,$$

where t₁₂ is the time between samples.

The yaw rate ω_{z} can also be found using a difference between wheel speeds:

$$2 {l}_{ω} {ω}_{𝓏 1} = {V}_{rf} - {V}_{lf} + {V}_{rr} - {V}_{lr}$$

where I_{w} is the lateral wheelbase, V_{rf} is the right front wheel speed, V_{Rr} is the right rear wheel speed, V_{if} is the left front wheel speed, and Vir is the left rear wheel speed.

Lateral acceleration A_{y} is calculated based on:

$${A}_{yg 1} - {A}_{y 1} + {b}_{1}$$

The IMU 42 outputs lateral acceleration including a gravity component (bank angle b₁), denoted as A_{yg1}:

$${A}_{yg 1} = {A}_{y 1} + {b}_{1}$$

Using the above information, inertial measurements the unknown inertial parameters in this example (yaw rate ω_{z}, dV_{y1}/dt, A_{y1}, and A_{yg1}) are calculated by solving:

$$[ \begin{matrix}{t}_{12} & 0 & {t}_{12} / {V}_{x} & 0 \\ - {V}_{x} & 1 & - 1 & 0 \\ 2 {l}_{w} & 0 & 0 & 0 \\ 0 & - 1 & 0 & 1\end{matrix} ] [ \begin{matrix}{ω}_{z 1} \\ {A}_{y 1} \\ \frac{{dV}_{y 1}}{dt} \\ {A}_{yg 1}\end{matrix} ] = [ \begin{matrix}∠ {V}_{2} - ∠ {V}_{1} \\ 0 \\ {V}_{rf} - {V}_{lf} + {V}_{rr} - {V}_{lr} \\ {b}_{1}\end{matrix} ] .$$

Measurements from sensors may be influenced by noise or otherwise have some level of uncertainty. Noise components are represented as n*e, where |e|<1, and n is a scaling factor representing an amount of noise in a particular signal or equation. For example, accounting for noise components, the following equations result:

$${b}_{1} = {\tilde{b}}_{1} + {n}_{b} {e}_{b}$$

$$∠ {V}_{2} - ∠ {V}_{1} = ∠ {\overline{V}}_{2} - ∠ {\overline{V}}_{1} + {n}_{a} {e}_{a}$$

$${V}_{rf} - {V}_{lf} + {V}_{rr} - {V}_{lr} = {\overline{V}}_{rf} - {\tilde{V}}_{lf} + {\tilde{V}}_{rr} - {\overline{V}}_{lr} + {n}_{v} {e}_{v} .$$

Inserting in the matrix equation yields:

$$[ \begin{matrix}{t}_{12} & 0 & {t}_{12} / {V}_{x} & 0 \\ - {V}_{x} & 1 & - 1 & 0 \\ 2 {l}_{w} & 0 & 0 & 0 \\ 0 & - 1 & 0 & 1\end{matrix} ] [ \begin{matrix}{ω}_{z 1} \\ {A}_{y 1} \\ \frac{{dV}_{y 1}}{dt} \\ {A}_{yg 1}\end{matrix} ] = [ \begin{matrix}∠ {\tilde{V}}_{2} - ∠ {\tilde{V}}_{1} + {n}_{a} {e}_{a} \\ {n}_{0} {e}_{0} \\ {\tilde{V}}_{rf} - {\tilde{V}}_{lf} + {\tilde{V}}_{rr} - {\tilde{V}}_{lr} + {n}_{v} {e}_{v} \\ {\tilde{b}}_{1} + {n}_{b} {e}_{b}\end{matrix} ] = = [ \begin{matrix}∠ {\tilde{V}}_{2} - ∠ {\tilde{V}}_{1} \\ 0 \\ {\tilde{V}}_{rf} - {\tilde{V}}_{lf} + {\tilde{V}}_{rr} - {\tilde{V}}_{lr} \\ {\tilde{b}}_{1}\end{matrix} ] + [ \begin{matrix}{n}_{a} {e}_{a} \\ {n}_{0} {e}_{0} \\ {n}_{v} {e}_{v} \\ {n}_{b} {e}_{b}\end{matrix} ] .$$

Scaling by noise level yields:

$${\underbrace{[ \begin{matrix}{t}_{12} / \text{?} & 0 & {t}_{12} / {V}_{x} / \text{?} & 0 \\ - {V}_{x} / {n}_{0} & 1 / {n}_{0} & - 1 / {n}_{0} & 0 \\ 2 {l}_{w} / {n}_{v} & 0 & 0 & 0 \\ 0 & - 1 / {n}_{b} & 0 & 1 / {n}_{b}\end{matrix} ]}}_{M} {\underbrace{[ \begin{matrix}{ω}_{z 1} \\ {A}_{y 1} \\ \frac{{dV}_{y 1}}{dt} \\ {A}_{yg 1}\end{matrix} ]}}_{x} = {\underbrace{[ \begin{matrix}∠ {\overline{V}}_{2} / \text{?} - ∠ {\overline{V}}_{1} / \text{?} \\ 0 \\ {\tilde{V}}_{rf} / \text{?} - {\tilde{V}}_{lf} / \text{?} + \text{?} / \text{?} - \text{?} / \text{?} \\ {\tilde{b}}_{1} / {n}_{b}\end{matrix} ]}}_{y} + [ \begin{matrix}\text{?} \\ \text{?} \\ \text{?} \\ \text{?}\end{matrix} ] .$$

$$\text{?} \text{indicates text missing or illegible when filed}$$

and we can estimate the unknowns (matrix x), by solving:

$$\hat{x} = {M}^{†} y .$$

In this example, which has four equations and four unknowns, the matrix is full rank and the scaling is without effect.

The following is an example in which the IMU 42 is low fidelity and provides yaw rate and A_{yg1}, and it is desired to improve the quality of these measurements using the dynamic parameter measurements of the previous example. Yaw rate and lateral acceleration with gravity can be represented as:

$${A}_{yg 1} = {\tilde{A}}_{yg 1} + {n}_{A} {e}_{A}$$

$${ω}_{z 1} = {\tilde{ω}}_{z 1} + {n}_{ω} {e}_{ω} ,$$

where ̌ indicates a measured parameter. Adding the above equations yields:

$${\underbrace{[ \begin{matrix}{t}_{12} / \text{?} & 0 & {t}_{12} / {V}_{x} / \text{?} & 0 \\ - {V}_{x} / {n}_{0} & 1 / {n}_{0} & - 1 / {n}_{0} & 0 \\ 2 {l}_{w} / {n}_{v} & 0 & 0 & 0 \\ 0 & - 1 / {n}_{b} & 0 & 1 / {n}_{b} \\ 1 / {n}_{ω} & 0 & 0 & 0 \\ 0 & 0 & 0 & 1 / {n}_{A}\end{matrix} ]}}_{M} {\underbrace{[ \begin{matrix}{ω}_{z 1} \\ {A}_{y 1} \\ \frac{{dV}_{y 1}}{dt} \\ {A}_{yg 1}\end{matrix} ]}}_{x} = {\underbrace{[ \begin{matrix}∠ {\tilde{V}}_{2} / \text{?} - ∠ \text{?} / \text{?} \\ 0 \\ {\tilde{V}}_{rf} / \text{?} - {\tilde{V}}_{lf} / \text{?} + {\tilde{V}}_{rr} / \text{?} - {\tilde{V}}_{lr} / \text{?} \\ {\tilde{b}}_{1} / {n}_{b} \\ {\tilde{ω}}_{z 1} / {n}_{ω} \\ {\tilde{A}}_{yg 1} / {n}_{A}\end{matrix} ]}}_{y} + [ \begin{matrix}\text{?} \\ \text{?} \\ \text{?} \\ \text{?} \\ \text{?} \\ \text{?}\end{matrix} ] .$$

$$\text{?} \text{indicates text missing or illegible when filed}$$

The unknowns (x) are estimated by:

$$\hat{x} = {M}^{†} y .$$

Due to the noise scaling, this estimate will depend the most on the least noisy measurements.

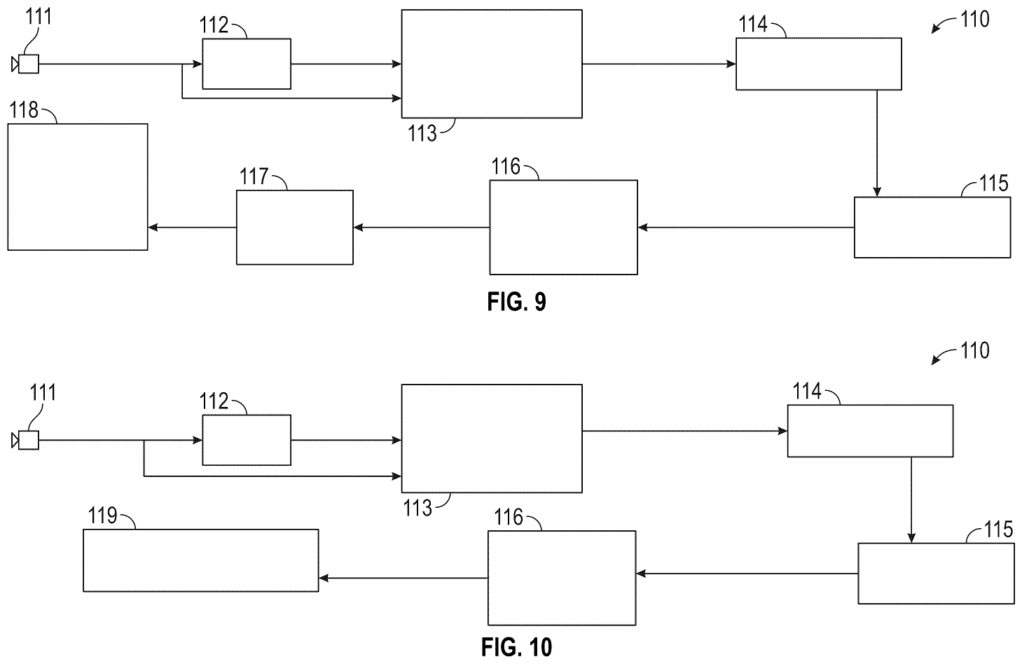

FIG. 9 depicts an embodiment of a method 110 of deriving inertial parameters from perception data. The method 110 is discussed in conjunction with blocks 101-118. The method 110 is not limited to the number or order of steps therein, as some steps represented by blocks 111-118 may be performed in a different order than that described below, or fewer than all of the steps may be performed.

The method 110 is discussed in conjunction with the vehicle of FIG. 1 and a processing system, which may be, for example, the computer system 62, the control system 40, or a combination thereof. Aspects of the method 100 are discussed in conjunction with the vehicle 10 for illustration purposes. It is noted the method 110 is not so limited and may be performed by any suitable processing device or system, or combination of processing devices.

At block 111, a set of images Iₜ, Iₜ₋₁, . . . Iₜ₋ₙ is collected from a camera (e.g., a front camera 20), and object detection is performed to identify various objects in each image (block 112). At block 113, masking is performed using the results of object detection and the set of images to identify dynamic objects across the images.

At block 114, feature extraction is performed to extract a set of m features (F¹, F², . . . F^{m}). At block 115, the features are matched across the images to generate a set of matched features F¹ₜ, F²ₜ, . . . , F¹ₜ₋ₙ, F²ₜ₋ₙ. across multiple images or frames.

At block 116, a camera pose (i.e., direction of camera) and a three-dimensional location of each matched feature are determined.

Camera pose and feature location can be regressed by projecting the features to the camera across frames, using a camera calibration matrix K (focal length and principal point):

$$[ \begin{matrix}{x}_{i} \\ {y}_{i} \\ 1\end{matrix} ] = ( K [ \begin{matrix}{X}_{i}^{c} \\ {Y}_{i}^{c} \\ {Z}_{i}^{c}\end{matrix} ] ) / {Z}_{i}^{C}$$

where xᵢ, yᵢ are the two-dimensional location of the features in an image i, and

$${X}_{i}^{c} , {Y}_{i}^{c} , {Z}_{i}^{c}$$

are three-dimensional (3D) locations of the features in the camera's coordinate system.

The 3D location of the features are related to camera pose by:

$$[ \begin{matrix}{X}_{i}^{c} \\ {Y}_{i}^{c} \\ {Z}_{i}^{c}\end{matrix} ] = [ {R}_{c} \vert {t}_{c} ] [ \begin{matrix}{X}_{i}^{w} \\ {Y}_{i}^{w} \\ {Z}_{i}^{w} \\ 1\end{matrix} ]$$

where

$${X}_{i}^{w} , {Y}_{i}^{w} , {Z}_{i}^{w}$$

are the coordinates or the feature in world coordinates, R_{c} is the camera rotation matrix and t_{c} is the camera translation vector. The set of parameters R_{c}, t_{c} and 3D point locations

$${X}_{i}^{w} , {Y}_{i}^{w} , {Z}_{i}^{w}$$

can be found by optimization along all features and all frames. Only the optimal parameters project the features to the measured locations xᵢ, yᵢ in the images.

At block 117, the camera pose per frame and camera orientation are processed to estimate the vehicle orientation and location.

Given the optimized camera pose and orientation (R_{c}, t_{c}) and the calibration of the camera pose and location with respect to the vehicle's coordinate system (R_{vc}, t_{vc}), the vehicle pose and location is given by:

$$[ {R}_{v} \vert {t}_{v} ] = [ {R}_{vc} \vert {t}_{vc} ] [ {R}_{c} \vert {t}_{c} ] .$$

At block 118, longitudinal and lateral vehicle speed and change in vehicle orientation are used to determined inertial parameters. The inertial parameters determined may include vehicle speed, as well as pitch, roll and yaw rates.

FIG. 10 depicts an alternative embodiment of the method 110. In this embodiment, instead of direct estimation (blocks 117 and 118), camera pose and orientation are fused with other measurements to determine vehicle speed and orientation (block 119).

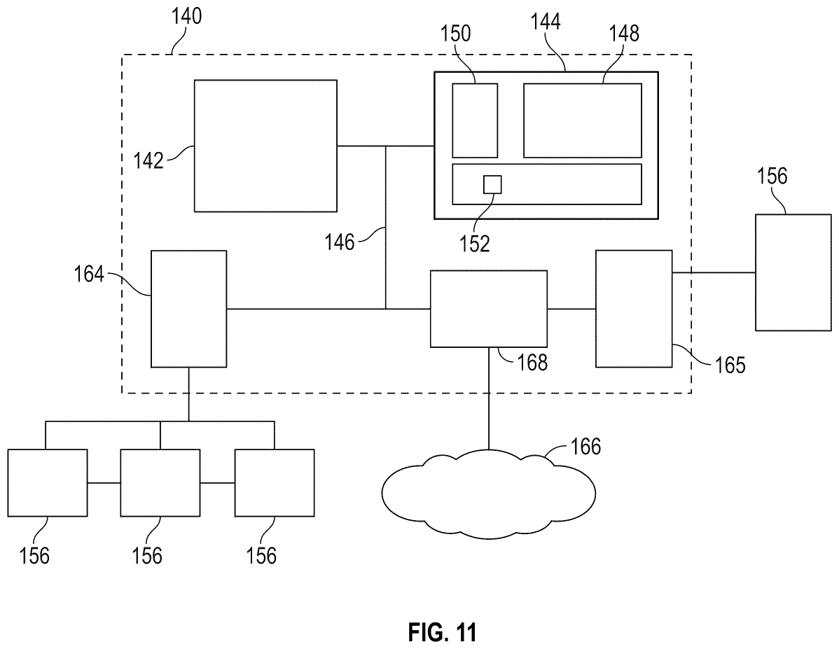

FIG. 11 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions discussed herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 140. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for measuring vehicle parameters, comprising:
an inertial measurement unit configured to measure an inertial parameter of a vehicle;
a virtual measurement unit configured to receive a plurality of measured parameters from one or more other sensors of the vehicle, and emulate the inertial parameter by combining the plurality of measured parameters; and
a controller configured to control vehicle operation based on at least one of the measured inertial parameter and the emulated inertial parameter.

2. The system of claim 1, wherein the plurality of measured parameters include at least one of a parameter indicative of an environment around the vehicle and a vehicle dynamics parameter.

3. The system of claim 2, wherein the plurality of measured parameters include at least one parameter derived from a visual odometry process using a series of camera images, and a dynamics parameter measured by a vehicle sensor.

4. The system of claim 1, wherein the virtual measurement unit is configured to apply a correction to the measured inertial parameter.

5. The system of claim 1, wherein the virtual measurement unit is configured to enhance the measured inertial parameter by fusing the measured inertial parameter and the plurality of measured parameters, to generate the emulated inertial parameter associated with a higher performance inertial measurement.

6. The system of claim 1, wherein the emulated inertial parameter is used to detect a fault in the inertial measurement unit.

7. The system of claim 1, wherein the virtual measurement unit is configured to provide redundancy to the inertial measurement unit, and operate to provide inertial measurements when the inertial measurement unit is in a fault condition.

8. The system of claim 1, wherein the inertial parameter is associated with a plurality of degrees of freedom, the measured inertial parameter is provided for a first subset of the plurality of degrees of freedom, and the emulated inertial parameter is provided for a second subset of the plurality of degrees of freedom.

9. A method of measuring vehicle parameters, comprising:
measuring an inertial parameter of a vehicle by an inertial measurement unit;
receiving a plurality of measured parameters from one or more other sensors of the vehicle by a virtual measurement unit, and emulating the inertial parameter by combining the plurality of measured parameters; and
controlling vehicle operation based on at least one of the measured inertial parameter and the emulated inertial parameter.

10. The method of claim 9, wherein the plurality of measured parameters includes at least one of a parameter indicative of an environment around the vehicle and a vehicle dynamics parameter.

11. The method of claim 9, further comprising applying a correction to the measured inertial parameter based on the emulated inertial parameter.

12. The method of claim 9, wherein emulating the inertial parameter includes enhancing the measured inertial parameter by fusing the measured inertial parameter and the plurality of measured parameters, to generate the emulated inertial parameter associated with a higher performance inertial measurement.

13. The method of claim 9, further comprising detecting a fault in the inertial measurement unit based on the emulated inertial parameter.

14. The method of claim 9, wherein the virtual measurement unit is configured to provide redundancy to the inertial measurement unit, and operate to provide inertial measurements when the inertial measurement unit is in a fault condition.

15. A vehicle system comprising:
a memory having computer readable instructions; and
a processing device for executing the computer readable instructions, the computer readable instructions controlling the processing device to perform a method comprising:
measuring an inertial parameter of a vehicle by an inertial measurement unit;
receiving a plurality of measured parameters from one or more other sensors of the vehicle by a virtual measurement unit, and emulating the inertial parameter by combining the plurality of measured parameters; and
controlling vehicle operation based on at least one of the measured inertial parameter and the emulated inertial parameter.

16. The vehicle system of claim 15, wherein the plurality of measured parameters include at least one parameter derived from a visual odometry process using a series of camera images, and a dynamics parameter measured by a vehicle sensor.

17. The vehicle system of claim 15, wherein the method includes applying a correction to the measured inertial parameter based on the emulated inertial parameter.

18. The vehicle system of claim 15, wherein emulating the inertial parameter includes enhancing the measured inertial parameter by fusing the measured inertial parameter and the plurality of measured parameters, to generate the emulated inertial measurement associated with a higher performance inertial measurement.

19. The vehicle system of claim 15, wherein the method includes detecting a fault in the inertial measurement unit based on the emulated inertial parameter.

20. The vehicle system of claim 15, wherein the virtual measurement unit is configured to provide redundancy to the inertial measurement unit, and operate to provide inertial measurements when the inertial measurement unit is in a fault condition.
